(19) United States
(12) Patent Application Publication
(10) Pub. No.: US 2024/0307259 A1
(43) Pub. Date: Sep. 19, 2024

(54) ELONGATED DEVICE WITH MULTIPLE ATTACHMENTS

(71) Applicant: Nathaniel Alexander Burger, Raleigh, NC (US)

(72) Inventor: Nathaniel Alexander Burger, Raleigh, NC (US)

(21) Appl. No.: 18/184,774

(22) Filed: Mar. 16, 2023

(51) Int. Cl. A61H 19/00

(52) U.S. Cl. CPC A61H 19/44; A61H 2201/1685

(57) ABSTRACT

A novel dildo device for use during sexual activity that is versatile as compared to current devices and possesses an adaptive end for receiving various tips, as well as a cavity for placing a vibrating device.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a dildo device for use in sexual activities.

### Description of Related Art

Generally, a dildo is a type of device used during sexual activity for general sexual activities, and is frequently used for anal, vaginal, or oral stimulation. Dildos are made of a variety of materials, including but not limited to silicone, rubber, plastic, wood, glass, metal, etc., and are generally phallic and elongated in shape. Dildos incorporate design features imitative of a human penis or are shaped as other objects including artificial and natural designs that often enhance sexual stimulation. In some cases, the distal end of a dildo (i.e., the base), has a handle, clip, fastener, or other means for attachment to a stationary or moving object, or for connection to the surface of a partner's body or a machine. Many dildos incorporate various massagers, vibrators, and textured surfaces, either directly or indirectly.

In use, dildos can be inserted into an orifice, such as a mouth, vagina, and/or anus of a person, either by the individual user, a partner or partners, or in conjunction with a machine. Dildos provide stimulation from friction through manipulation upon sexual organs and erogenous zones and by pressure upon a cavity and surrounding organs and tissue when inserted into an orifice. Dildos are often used with natural and artificial lubrication depending on the application, use, and desired sensation by the users.

### BRIEF SUMMARY OF THE INVENTION

The present invention relates to a novel dildo device which overcomes the problems with previous and current dildo designs. By leaving an opening at the proximal end, the present invention is adapted to receive various tips and contains a hollow shaft with an optional space to place a vibrating device. An individual could potentially have one dildo for many different uses depending on what tip is used, making it versatile.

Accordingly, in one embodiment, there is a device for use in sexual activity comprising:
a) a cylindrical elongate member having a distal and a proximal end, the elongate member being straight with a single bend from about 2 inches to about 3 inches from the proximal end;
b) wherein there is a hollow shaft that runs from the distal end to the proximal end of the cylindrical elongate member; and
c) wherein the proximal end of the hollow shaft is shaped to replaceably accommodate a tip end.

### BRIEF DESCRIPTION OF THE DRAWINGS

FIG. 1 is a perspective and exploded view of the present invention.

FIG. 2 is a perspective view showing a representative example of a tip end of the present invention.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “sexual activity” refers to use of the device for sexual stimulation either alone or with others. This includes application to the genitalia as well as other locations on the body. This means there are a variety of circumstances any dildo can be used for. This particular dildo device has advantages over previous dildos as described herein.

As used herein, the term “cylindrical elongate member” refers to the general shape of the device of the present invention. As shown in the drawings, it consists of a cylinder with a straight portion that has a single bend and is in the general shape of a penis. In general and in one embodiment, the cylindrical elongate member is from about 4 inches to about 6 inches.

As used herein, the term “straight” and “single bend” refers to the distal portion being relatively straight as shown in the drawings. The straight portion comprises the distal portion of the device. The bent portion is comprising the proximal portion of the cylindrical elongate member. At the intersection of the proximal and distal portions is a bend. The bend in the elongate member relative to the straight portion is from about 30° to about 45°. The angle is designed for intravaginal use in terms of coming into contact with the G-spot better. The bend is about 2 inches to 3 about inches from the proximal tip end.

As used herein, the term “hollow shaft” refers to a shaft running the length of the cylindrical elongate member from the proximal end to the distal tip. At the distal tip, the hollow shaft is large enough to accommodate a removable vibrating device. At the proximal tip, the opening is designed to accommodate a removable tip end with different functions inserted therein. Since it is removable, that means an individual can have a single dildo with dozens of different tip shapes for different uses, rather than dozens of dildos, making this new device versatile. In one embodiment, the tip end has a distal bulbous end for inserting and holding the tip end in place. Insertion of the tip end can be enhanced by squeezing the shaft which creates a slight internal suction.

As used herein, the term “replaceably accommodate” refers to the proximal tip being able to receive interchangeable tip ends of any desired shape by having a distal end of the tip end that fits into the hollow shaft at the proximal end of the dildo for holding it in place during use.

As used herein, the term “tip end” refers to removable devices that insert into the proximal tip for different uses of the device.

As used herein, the term “vibrating device” refers to a battery-operated device that fits into the hollow shaft at the distal end of the cylindrical elongate member. The device can vibrate when turned on to increase the stimulation. In this case, it's removable as opposed to current vibrating dildos that have the vibrating device permanently inserted.

### DRAWINGS

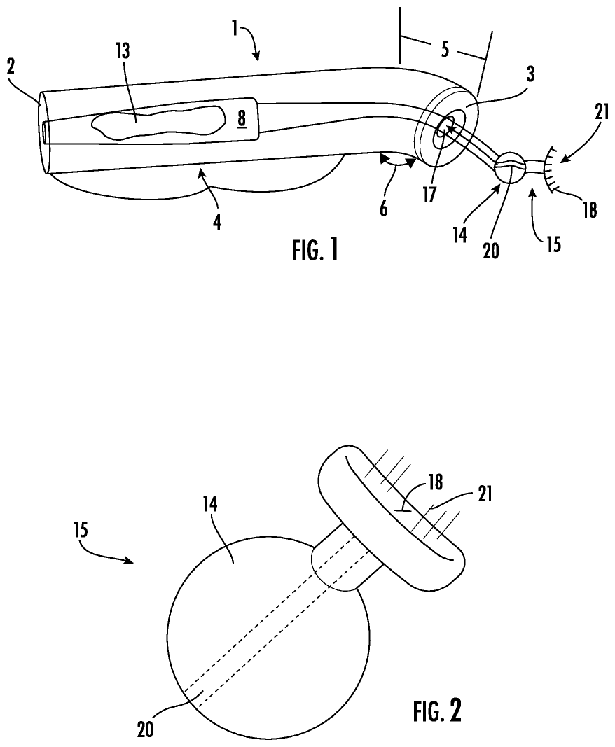

Now referring to the drawings, FIG. 1 is a perspective and exploded view of the device. In this view, cylindrical elongate member 1 has distal end 2 and proximal end 3. The distal portion 4 is relatively straight and the proximal portion 5 is bent 6 at an angle relative to distal portion 4. A hollow shaft 8 extends from the distal end 2 to the proximal end 3. The distal end 2 of the hollow shaft 8 is enlarged to accommodate an optional vibrator 13. The proximal end 3 of the hollow shaft 8 is shaped (circular in this embodiment) to receive and hold a tip end (bulbous embodiment 14) 15 with a hollow shaft 20 that extends to the hollow shaft 8. The proximal end of the tip end 18 shows a stimulatory shape 21 for use on the cylindrical elongate member 1.

FIG. 2 shows the tip end 15 (bulbous embodiment 14) which can be inserted in proximal hole 17 (shown in FIG. 1) of the hollow shaft 8. In this view, the stimulatory shape 21 is visible.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A device for use in sexual activity comprising:
a) a cylindrical elongate member having a distal and a proximal end, the elongate member being straight with a single bend from about 2 inches to about 3 inches from the proximal end;
b) wherein there is a hollow shaft that runs from the distal end to the proximal end of the cylindrical elongate member; and
c) wherein the proximal end of the hollow shaft is shaped to replaceably accommodate a tip end.

2. The device according to claim 1 wherein the distal end of the of the cylindrical elongate member is adapted to receive a vibrating device.

3. The device according to claim 1 wherein a tip end is positioned in the proximal end of the hollow shaft.

4. The device according to claim 1 wherein the cylindrical elongate member is about 4 inches to about 6 inches in length.

5. The device according to claim 1 wherein the bend is from about 30° to about 45° relative to the straight portion.
